(19) United States
(12) Patent Application Publication
(10) Pub. No.: US 2007/0102888 A1
(43) Pub. Date: May 10, 2007

(54) Ring-shaped metal gasket

(75) Inventors: Kenichi Takahiro, Shizuoka (JP); Hideaki Mori, Shizuoka (JP); Kanji Hanashima, Shizuoka (JP); Toshihiro Oikawa, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Nichias Corporation, Tokyo (JP); Honda Motor Co., Ltd., Tokyo (JP)

(21) Appl. No.: 10/551,438

(22) PCT Filed: Mar. 22, 2004
(86) PCT No.: PCT/JP04/03829

§ 371 Date: Dec. 11, 2006

(30) Foreign Application Priority Data
Mar. 31, 2003 (JP) 2003-095176

(51) Int. Cl. F16L 21/05

(52) U.S. Cl. 277/603

(57) ABSTRACT

A ring-shaped metal gasket 10 in which a metallic ring 10b is fitted to at least one of two valley portions 11b, 12b in the ring-shaped metal gasket 10a. The metal gasket 10 is free of plastic deformation even if a large compressive load is applied thereto and difficult to undergo fatigue destruction. Even if a difference in pressure between a fluid side to be sealed and a non-fluid side on the opposite side is high, the gasket is hard to damage.

### TECHNICAL FIELD

The present invention relates to a ring-shaped metal gasket which is not plastically deformed even if a large compressive load is applied, presenting an excellent durability.

### BACKGROUND ART

Conventionally, a rubber-made gasket, a resin-made gasket or a metal gasket represented by an O-ring has been used as the seal for a vacuum apparatus and the seal for a pressure fluid pipe and the like. Of these, such metal gaskets as so-called letter C shaped ring, letter S shaped ring and letter E shaped ring have been used at a place requiring elastic restoration performance under high temperature environment.

The letter E shaped ring has been disclosed in, for example, patent document 1, Japanese Patent Application Laid-Open No. 2002-5290. The gasket having the E-shaped section has solved a problem of the gasket having the C-shaped section that improving its sealing performance lowers its displacement follow-up capacity and improving the displacement follow-up capacity lowers the sealing performance. Consequently, an excellent sealing performance can be obtained by exerting elastic repulsive force (sealing load) against a compressive load and at the same time, the gasket deflects elastically in a wide range, so that expansion force corresponding to deflection of the compressive load is exerted so as to obtain an excellent displacement follow-up capacity.

Japanese Patent Application Laid-Open No.HEI8-145183 of the patent document 2 has disclosed a vacuum sealing gasket which is a metallic elastic structure body having V-shaped or W-shaped longitudinal section and composed of rubber films 0.1 μm to 0.5 mm thick for a sealing face, while a rubber ring is fitted to a valley portion of the metallic elastic structure body. According to this vacuum sealing gasket, because the metallic elastic structure body follows up uneven sealing gap in the sealing portion and the rubber film having a high shape restoration capacity to be combined is formed thin, the quantity of discharged gas even in even a super vacuum region is small and further this can be used repeatedly.
(Patent document 1) Japanese Patent Application Laid-Open No. 2002-5290 (claim 1)
(Patent document 2) Japanese Patent Application Laid-Open No.HEI8-145183 (claim 1 to claim 3)

However, as for a conventional S-shaped gasket or E-shaped gasket, if a large compressive load P over the elasticity limit of its shape is applied as shown in FIG. 15, stress is concentrated to the rear faces of the C-shaped section portions 161, 161 so that plastic deformation occurs. In this case, there is such a problem that no sealing performance is secured because its elastic repulsive force cannot be exerted. In the meantime, in FIG. 15, reference numerals 162, 163 denote a sealing object member. Further, if it receives vibration under a compressive load near its elasticity limit repeatedly, there is another problem that the gasket undergoes metal fatigue so that fatigue destruction occurs, thereby durability being dropped. In case where a difference in pressure between the fluid side to be sealed and the non-fluid side on an opposite side is high, usually, the S-shaped or E-shaped ring gasket is manufactured of a thin plate to secure plasticity, and there is another problem that it maybe damaged due to that pressure difference. Further, a gasket produced by combining rubber rings as disclosed in Japanese Patent Application Laid-Open No.HEI8-145183 is not yet sufficient for assisting elasticity of the metallic elastic structure body and it cannot be used under high temperatures.

Accordingly, an object of the present invention is to provide a ring-shaped metal gasket which is free of plastic deformation even if a large compressive load is applied thereto and difficult to undergo fatigue destruction and hard to damage even if a difference in pressure between the fluid side to be sealed and the non-fluid side on an opposite side is high.

### DISCLOSURE OF THE INVENTION

Under such a situation, as a result of a keen examination, the inventor of the present invention and other people have found out that the ring-shaped metal gasket having an S-shaped section or an E-shaped section, in which the metallic ring is fitted to at least one of two or three valley portions thereof, is free of plastic deformation even when a large compressive load is applied and difficult to undergo fatigue destruction and then, reached accomplishment of the present invention.

That is, the present invention (1) provides a ring-shaped metal gasket which is disposed between two sealing object members and in which at least two pieces of valley portions dented in a second direction perpendicular to a first direction extending from a contact portion of one sealing object member to the other sealing object member are provided, wherein a metallic ring is fitted to at least one of the valley portions. With such a structure, even if a large compressive load is applied, the metallic ring fitted to the valley portion acts as a reinforcement member thereby suppressing plastic deformation of the ring-shaped metal gasket and at the same time, preventing generation of metal fatigue in the ring-shaped metal gasket. If the metallic ring is provided on both the valley portions on the fluid side and non-fluid side, an influence upon the metal gasket by changes in pressure on the fluid side and non-fluid side can be suppressed.

The present invention (2) provides the ring-shaped metal gasket wherein at least one of the metallic rings is fitted to the valley portion on a lower pressure side of a fluid side to be sealed and a non-fluid side on an opposite side. With such a structure, even if a difference in pressure between the fluid side to be sealed and the non-fluid side on an opposite side increases, the ring-shaped metal gasket can be formed thin because a reinforcement metallic ring is fitted to a deformation side, so that the weight thereof can be reduced and damage accompanied by the reduction of the thickness can be suppressed.

Further, the present invention (3) provides the ring-shaped metal gasket wherein at least one of the metallic rings is fitted to the valley portion on a lower temperature side of the fluid side to be sealed and the non-fluid side on an opposite side. According to the present invention, heat received by the ring-like gasket is transmitted to a sealing object member thereby suppressing heat influence upon the metallic ring and at the same time improving its heat resistance.

Further, the present invention (4) provides the ring-shaped metal gasket wherein the metallic rings are fitted to all the valley portions of the ring-shaped metal gasket. According to the present invention, it is not necessary to take care of a position (direction) in which the metallic ring is fitted when installing the ring-shaped metal gasket and therefore, mistake in the installation can be prevented. Further, because this ring-shaped metal gasket can substitute a gasket in which a metallic ring is fitted to only one side of plural valley portions, it is not necessary to prepare the gasket in which the metallic ring is fitted to only this one side for a special purpose and thus, the quantity of components can be reduced.

Further, the present invention (5) provides the ring-shaped metal gasket wherein the maximum dimension in the diameter direction of a longitudinal section of the metallic ring is larger than the maximum dimension in a direction perpendicular to the diameter direction thereof. According to the present invention, an effect of suppressing the plastic deformation in the vicinity of a junction point between the C-shaped section portion and the inverted-C shaped section portion in, for example, an S-shaped or inverted S-shaped metal gasket is great.

Further, the present invention (6) provides the ring-shaped metal gasket wherein the metallic ring is a metallic O-ring, metallic irregular cross section ring or metallic rectangular cross section ring. According to the present invention, when manufacturing the ring-shaped metal gasket, a room for material selection is increased.

### BRIEF DESCRIPTION OF THE DRAWINGS

FIG. 1 is a partial sectional view showing a non-compressive condition when the ring-shaped metal gasket according to a first embodiment is mounted. The arrow of a symbol m in FIG. 1 indicates a first direction and the arrow of a symbol n indicates a second direction (the same things for FIGS. 2-4).

FIG. 2 is a partial sectional view showing a compression state when the ring-shaped metal gasket of the first embodiment is mounted.

FIG. 3(A) is a perspective view of the ring-shaped metal gasket of the second embodiment.

FIG. 3(B) is a plan view thereof,

FIG. 3(C) is a front view thereof, and

FIG. 3(D) is an expanded view along the line A-A of FIG. 3(B).

FIG. 4 is a diagram showing a modification of the ring-shaped metal gasket of the second embodiment.

FIG. 5 is a diagram showing other modification of the ring-shaped metal gasket of the second embodiment.

FIG. 6 is a partial sectional view showing a compression state when the ring-shaped metal gasket of the third embodiment is mounted.

FIG. 7 is a partial sectional view of a modification of the ring-shaped metal gasket of the third embodiment.

FIG. 8(A) is a perspective view of the ring-shaped metal gasket of the fourth embodiment,

FIG. 8(B) is a plan view thereof,

FIG. 8(C) is a front view thereof and

FIG. 8(D) is an expanded view taken along the line B-B of FIG. 8(B).

FIG. 9 is a diagram showing a modification of the ring-shaped metal gasket of the fourth embodiment.

FIG. 10(A) is a perspective view of the ring-shaped metal gasket of the fifth embodiment,

FIG. 10(B) is a plan view thereof,

FIG. 10(C) is a front view thereof and

FIG. 10(D) is an expanded view along the line C-C.

FIG. 11 is a diagram showing a modification of the ring-shaped metal gasket of the fifth embodiment.

FIGS. 12-14 are diagrams showing the ring-shaped metal gasket of the sixth embodiment.

FIG. 15 is a partial sectional view showing a compression state when a conventional S-shaped metal gasket is mounted.

### BEST MODE FOR CARRYING OUT THE INVENTION

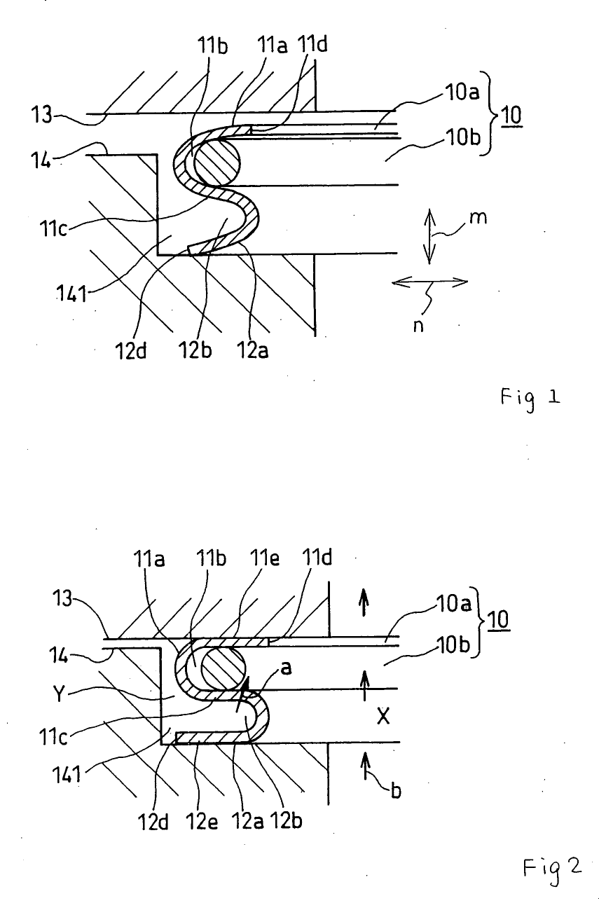

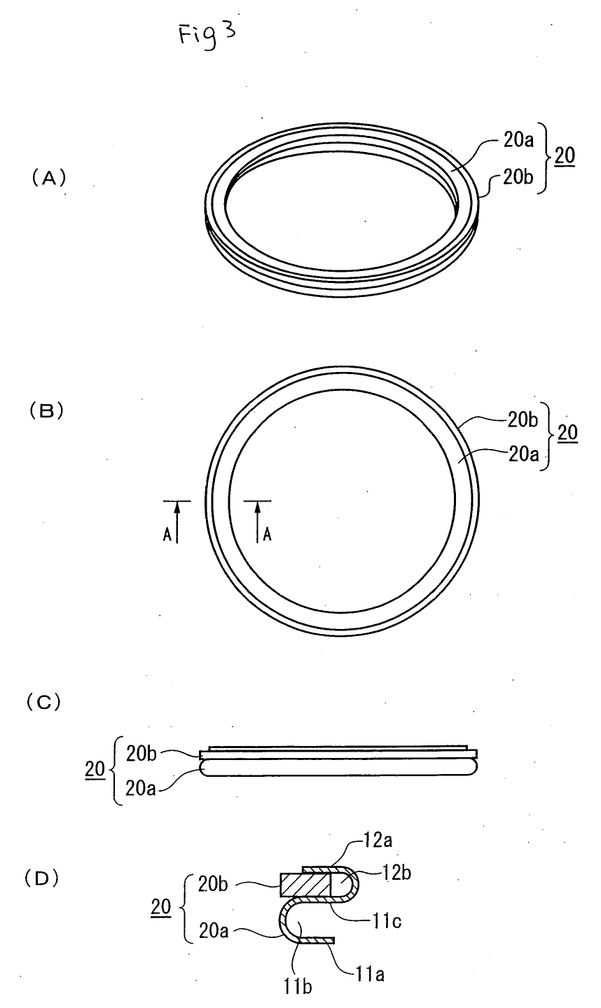

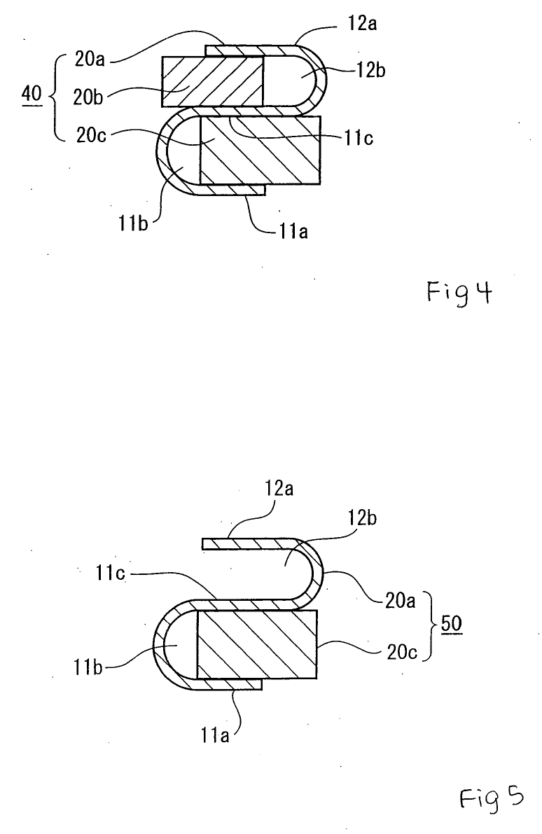

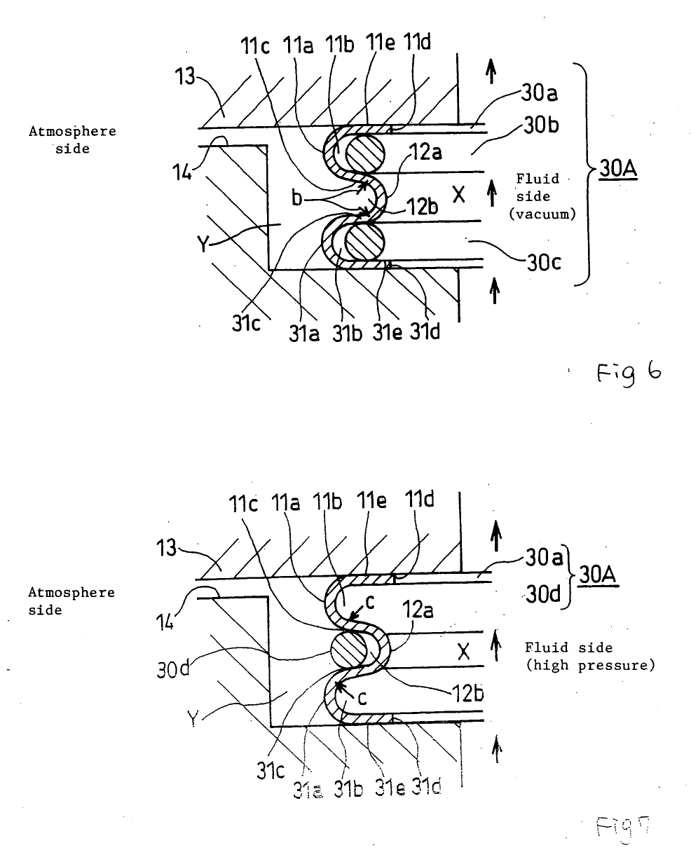

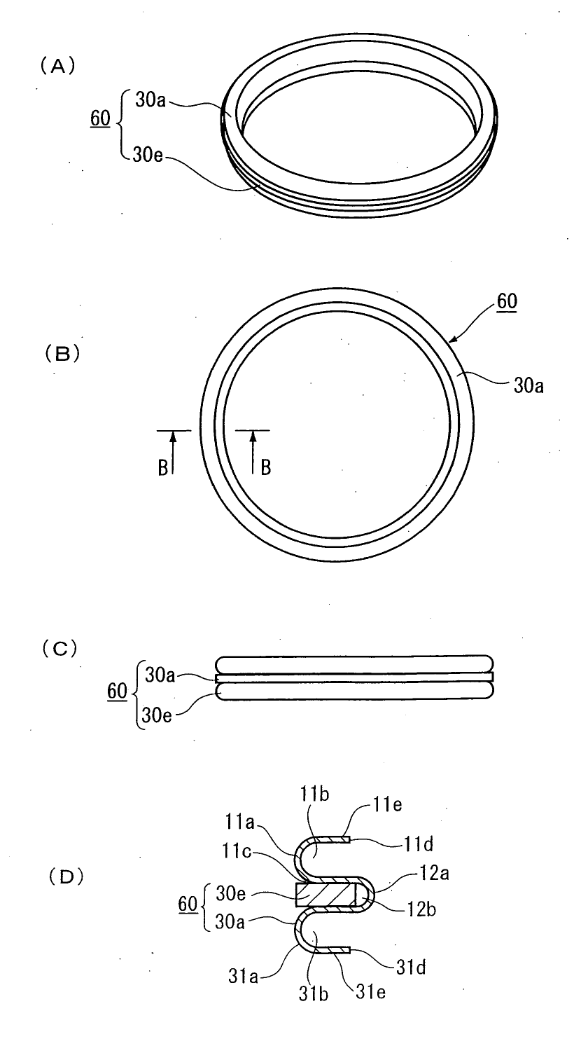

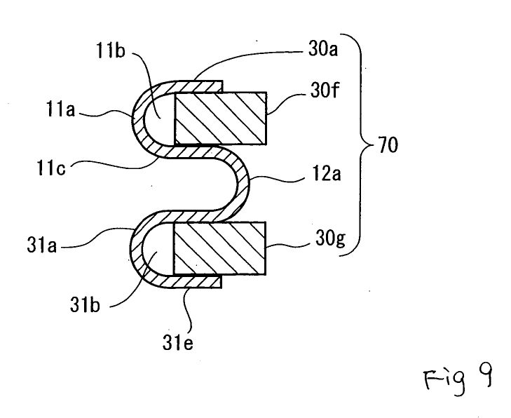

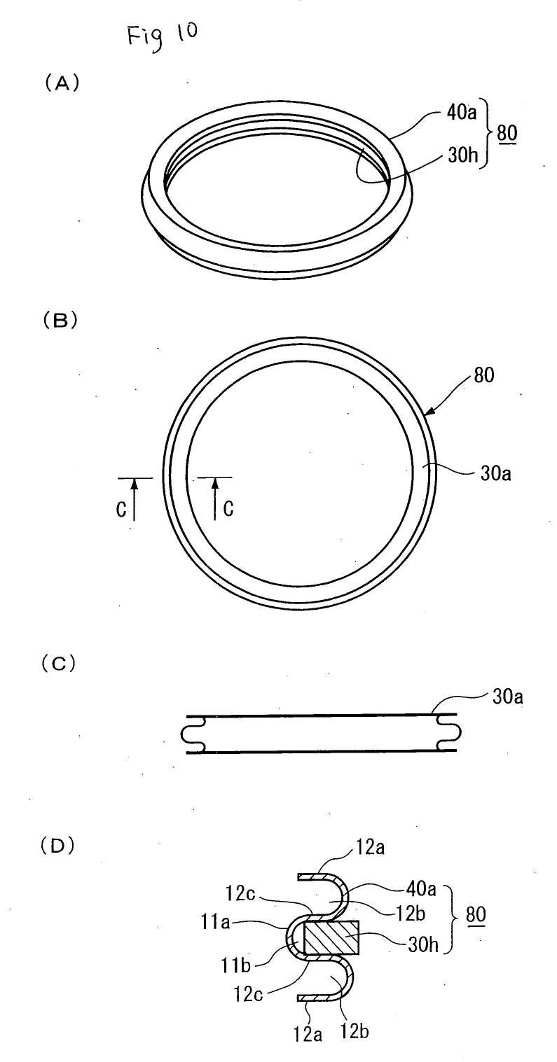

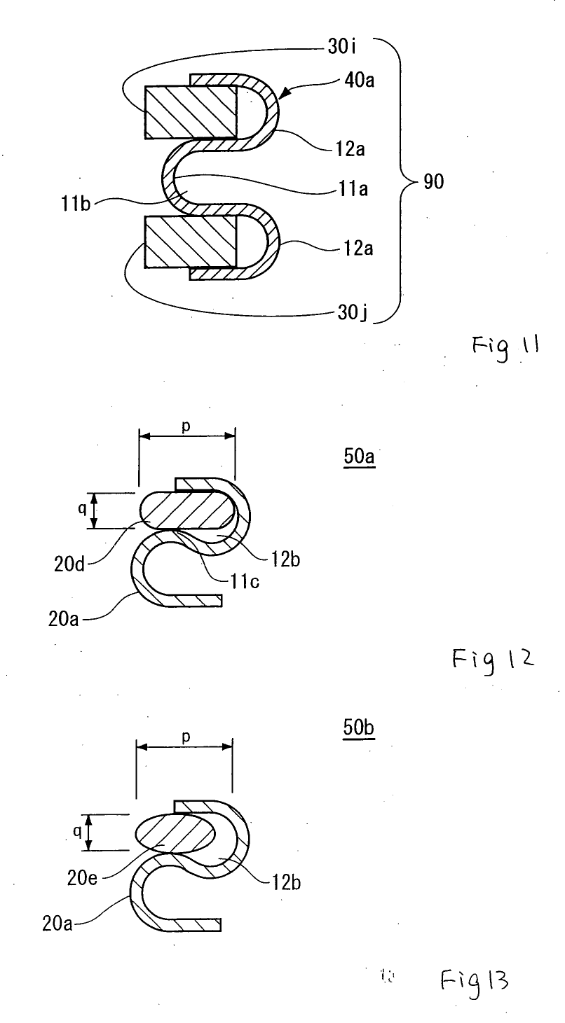

Next, the ring-shaped metal gasket of the first embodiment of the present invention will be described with reference to FIGS. 1, 2.

The ring-shaped metal gasket 10 of this embodiment comprises a ring-shaped metal gasket 10A (hereinafter referred to as S-shaped metal gasket) having so-called S-shaped longitudinal section, in which two valleys dented in a second direction perpendicular to a first direction extending from a contact portion of one sealing object member 13 to a contact portion of the other sealing object member 14 are provided, and a metallic O-ring 10b. Here, the first direction is a direction which extends between the sealing object members 13 and 14 and the second direction is a direction perpendicular to the first direction. The S-shaped metal gasket 10a is a ring-shaped metal integrated body formed to have a section in which a C-shaped sectional portion 11a, which is a valley dented to the non-fluid side in the second direction, and an inverted C-shaped sectional portion 12a, which is a valley dented to the fluid side in the second direction, are continuous at a junction point 11c which is an end point of the respective C shapes, and includes two valleys, a valley portion 11b having the C-shape located on the fluid side to be sealed (right side in the same Figure) and a valley portion 12b having the inverted-C shape located on the non-fluid side on the opposite side (right side in the same Figure). The S shape does not means such a shape in a rigid meaning and in addition to the shape shown in FIG. 1, for example, a curled shape in which the end portions 11d, 12d at the front ends of the C shape and the inverted C shape are bent inward just like a letter “C” is permitted or such a shape in which the side members of the C shape or the inverted C shape making contact with a sealing object member form flat portions as shown in FIG. 2 from when it is not compressed is also permitted.

The metallic O-ring 10b is a ring-shaped metal object having a circular section and fitted to the valley portion 11b located on the fluid side to be sealed in FIGS. 1, 2. A preferred diameter of the circular section of the metallic O-ring 10b is of such a dimension which allows it to be fitted manually to the valley portion 11b of the S-shaped metal gasket 10a in non-compressive condition so that it makes contact with both inside faces opposing each other in the C-shaped valley portion. If the diameter of the circular section is too large, it cannot be fitted to the valley portion of the S-shaped metal gasket 10a or even if it is fitted by expanding its opening forcibly, the displacement follow-up capacity is deteriorated. If the diameter of the circular section is too small, when a large compressive load is applied, the plastic deformation of the S-shaped metal gasket 10a cannot be prevented.

As an example in which the metallic O-ring 10b is fitted to the valley portion of the S-shaped metal gasket 10a of this embodiment, in addition to the embodiments shown in FIGS. 1, 2, there are an example in which a metallic O-ring is fitted to the valley portion 12b located on the non-fluid side of the S-shaped metal gasket 10aand an example in which two metallic O-rings are fitted to the two valley portions 11b, 12b. Of these, the example in which the two metallic O-rings are fitted to the two valley portions 11b, 12b of the S-shaped metal gasket 10a is preferable because it can block plastic deformation securely of the S-shaped metal gasket 10a even if a large compressive load is applied. Further, the metallic O-ring 10b is permitted to be hollow. Further instead of the metallic O-ring, it is permissible to fit a metallic rectangular section ring.

Next, the ring-shaped metal gasket of the second embodiment of the present invention will be described with reference to FIGS. 3-5. In FIGS. 3-5, like reference numerals are attached to the same components as those in FIG. 1 and description thereof is omitted while mainly different points will be described. That is, the ring-shaped metal gasket 20 of the second embodiment is different from the ring-shaped metal gasket 10 of the first embodiment in that an inverted S-shaped metal gasket 20a is employed instead of the S-shaped metal gasket 10a, the valley portion 12b located on the non-fluid side is smaller than the valley portion 11b located on the fluid side and a metallic ring which is fitted to the valley portion 12b located on the non-fluid side is a metallic rectangular section ring 20b. In the ring-shaped metal gasket 20, a metallic rectangular section ring 20c may be fitted to the valley portion 11b located on the fluid side (FIG. 4) or it is permissible to omit the metallic rectangular section ring 20b in the valley portion 12blocated on the non-fluid side while keeping only the metallic rectangular section ring 20c fitted to the valley portion located on the fluid side (FIG. 5).

The thickness of the metallic rectangular section rings 20b, 20c used in the ring-shaped metal gaskets 20, 40, 50 is preferred to be to such an extent that they can be fitted manually to the valley portions 11b, 12b of the S-shaped metal gasket 20a in non-compressive condition while they make contact with both the inner side faces opposing in the C-shaped valley portion. If the thickness is too large, it cannot be fitted to the valley portions of the S-shaped metal gaskets 10a, 20a or even if its opening is expanded forcibly, the displacement follow-up capacity is deteriorated. Further, if the thickness is too small, when a large compressive load is applied, the plastic deformation of the S-shaped metal gaskets 10a, 20a cannot be prevented. The width of the metallic rectangular section rings 20b, 20c is preferred to be to such an extent that it is almost accommodated in the valley portion of the S-shaped metal gaskets 20a, 20b or it is slightly projected because a stable displacement follow-up capacity can be obtained. Further, the metallic rectangular section ring 20b is permitted to be hollow.

The manufacturing method of the S-shaped metal gaskets 10a, 20a is not restricted to any particular one, but it is manufactured by plastically deforming a predetermined metal base material corresponding to an object by combining for example, drawing, bending or pressing appropriately. As the metal base material, for example, stainless steel, nickel base alloy and the like can be mentioned. The metallic materials of the S-shaped metal gaskets 10a, 20a, the metallic O-ring 10b and the metallic rectangular section rings 20b, 20c are permitted to be the same or different. The surfaces of the S-shaped metal gaskets 10a, 20a, the metallic O-ring 10b and the metallic rectangular section rings 20b, 20c maybe plated with silver.

Next, the use method of the ring-shaped metal gasket 10 will be described. As for an application place, the ring-shaped metal gasket 10 is fitted to a concave portion 141 in the sealing object member 14 as shown in, for example, FIG. 1. Next, the sealing object members 13, 14 are tightened so that a gap between them is reduced. The ring-shaped metal gasket 10 is sandwiched under a predetermined compressive load so that it is kept in the tightening condition (FIG. 2). Although when the ring-shaped metal gasket 10 of this embodiment is tightened under a predetermined compressive load, a contact between the S-shaped metal gasket 10a and the sealing object member 13 and a contact between the S-shaped metal gasket 10a and the sealing object member 14 are carried out through the facial contacts of the flat portion 11e and the flat portion 12e, the present invention is not restricted to this example, but for example, they may make a linear contact as shown in FIG. 15. The use method of the ring-shaped metal gaskets 20, 40, 50 is the same as the aforementioned one.

According to the ring-shaped metal gaskets 10, 20, 40, 50, even if a large compressive load is applied, the metallic ring fitted into the valley portion acts as a reinforcement member thereby preventing the ring-shaped metal gasket having S-shaped longitudinal section from being plastically deformed. Further, even if it receives vibration repeatedly under a large compressive load, similarly the metallic ring prevents the ring-shaped metallic gasket having S-shaped longitudinal section from being deformed and therefore, the gasket is difficult to undergo metal fatigue.

Preferably, in the ring-shaped metal gasket 10, at least one of the metallic O-rings 10b is fitted to the valley portion on a lower pressure side of the fluid side X to be sealed and the non-fluid side Y on the opposite side. For example, if the pressure P_{X} on the fluid side X to be sealed and the pressure P_{Y} on the non-fluid side Y on the opposite side are in the relationship of P_{X}≦P_{Y}, the metallic O-ring is fitted to the valley portion 11b located on the fluid side X to be sealed. Consequently, even if deformation due to a difference in pressure occurs in the direction of an arrow a in FIG. 2 in a gasket produced of a thin plate, this does not lead to plastic deformation so that destruction is unlikely to occur because the reinforcement metallic O-ring 10b is fitted to the deformation side. In FIG. 2, if the metallic O-ring is fitted not to the fluid side but to the valley portion 12b located on the non-fluid side although not shown here, the gasket becomes likely to be deformed in a direction in which the C shape of the C-shaped sectional portion 11a is crushed. However, because the metallic O-ring fitted to the valley portion 12b acts as a reinforcement member against a compressive load in a tightening direction (first direction), the plastic deformation of the gasket can be prevented, so that destruction is difficult to occur. Even if this metallic O-ring 10b is replaced with the metallic rectangular section ring 20b, 20c, the same effect is exerted.

In the ring-shaped metal gasket 10, preferably, at least one of the metallic rings is fitted to the valley portion on a lower temperature side of the fluid side X to be sealed and the non-fluid side on the opposite side. For example, if the temperature pressure T_{X} on the fluid side X to be sealed and the temperature T_{Y} on the non-fluid side Y on the opposite side are in the relationship of T_{Y}≦T_{X} the metallic ring is fitted to the valley portion 12b on the non-fluid side Y. Consequently, heat received by the ring-shaped gasket is transmitted to the sealing object member and heat influence upon the metallic ring can be suppressed, thereby improving heat resistance.

The ring-shaped metal gaskets 10, 20, 40, and 50 are applied to, for example, seal for vacuum apparatus and seal for pressure fluid pipe and the like. Fluid indicated with a symbol b in FIG. 2 is permitted to be any one of gas and liquid and its use temperature is in a range of −200 to 500° C. Particularly, under a high temperature condition in which the temperature on the fluid side is in a range of 300 to 500° C., the effect of the present invention can be exerted securely because the ring-shaped metal gasket 10 of this embodiment uses no rubber member, which is preferable.

Next, the ring-shaped metal gasket 30A of the third embodiment of the present invention will be described with references to FIGS. 6, 7. In FIGS. 6, 7, like reference numerals are attached to the same components as FIG. 2 and description thereof is omitted while mainly different points will be described. That is, the ring-shaped metal gasket 30A of the third embodiment is different from the ring-shaped metal gasket 10 of the first embodiment in that the S-shaped metal gasket is replaced with a metal gasket having a substantially E-shaped longitudinal section (hereinafter referred to as “substantially E-shaped metal gasket”).

The ring-shaped metal gasket 30A of the third embodiment is constituted of a combination of the substantially E-shaped metal gasket 30a and the metallic O-ring. The substantially E-shaped metal gasket 30a is a ring-shaped metal integrated body formed to have such a sectional shape in which a first C-shaped section portion 11a which is a valley portion dented to the non-fluid side in the second direction and an inverted C shaped section portion 12a which is dented to the fluid side in the second direction are continuous through a junction point 11c which serves as end portions of the respective C shapes and the inverted C-shaped section portion 12aand a second C-shaped section portion 31a, which is a dented portion to the non-fluid side in the second direction, are continuous through a junction point 31c which serves as end portions of the respective C shapes. Consequently, this has three valley portions, two valley portions 11b, 31b originated from the C shape on the fluid side to be sealed (right side in the same Figure) and a valley 12b originated from the inverted-C shape located on the non-fluid side (left side in the same Figure) on the opposite side. The substantially E shape does not mean such a shape in a rigid meaning and in addition to the shape shown in FIG. 6, the C shape or the inverted C shape may be in such a curled shape that end portions lid, 31d are bent inward just like a letter “C”. Further, the first, second C-shaped section portions 11a, 31a and the inverted-C shaped section portion 12a do not need to be of the same shape, but for example, the inverted-C shaped section portion 12a is permitted to be like a lateral V shape which is presented by turning the V shape by 90 degrees counterclockwise.

As an example in which the metallic O-ring is fitted to the valley portion of the substantially E-shaped metal gasket 30a in the ring-shaped metal gasket 30A of the third embodiment, an example in which two metallic rings are fitted to the valley portion 11b and the valley portion 31b located on the fluid side X to be sealed (FIG. 6), an example in which a single metallic O-ring is fitted to the valley portion 12b on the non-fluid side Y (FIG. 7) and an example in which three metallic O-rings are fitted to the three valley portions 11b, 12b and 31b can be mentioned. Of these, the example in which the three metallic O-rings are fitted to the three valley portions 11b, 12b is preferable because the plastic deformation of the substantially E shaped metallic gasket 10a can be prevented securely even if a large compressive load is applied.

According to the ring-shaped metal gasket 30A of the third embodiment, even if a large compressive load is applied, the metallic O-ring fitted to the valley portion acts as a reinforcement member thereby preventing the plastic deformation of the ring-shaped metal gasket having the substantially E-shaped longitudinal section. Further, even if vibration is received repeatedly under a large compressive load, the gasket is hard to undergo metal fatigue because the deformation of the ring-shaped metal gasket having the substantially E-shaped longitudinal section is prevented by the metallic O-ring likewise.

Next, the ring-shaped metal gasket of the fourth embodiment of the present invention will be described with reference to FIGS. 8, 9. In FIGS. 8, 9, like reference numerals are attached to the same components as FIG. 6 and description thereof is omitted while mainly different points will be described. That is, the ring-shaped metal gasket 60 of the fourth embodiment is different from the ring-shaped metal gasket 30A of the third embodiment in that a metallic rectangular section ring 30e is employed as a metallic ring to be fitted to the valley portion 12b located on the non-fluid side and that the valley portion 12b located on the non-fluid side is formed deep. In the ring-shaped metal gasket 60, it is permissible to omit the metallic rectangular section ring 30e fitted to the valley portion 12b located on the non-fluid side and fit metallic rectangular section rings 30f, 30g to the valley portions 11b, 31b (FIG. 9).

Next, the ring-shaped metal gasket of the fifth embodiment of the present invention will be described with reference to FIGS. 10, 11. In FIGS. 10, 11, like reference numerals are attached to the same components as FIG. 8 and description thereof is omitted while mainly different points will be described. That is, the ring-shaped metal gasket 80 of the fifth embodiment is different from the ring-shaped metal gasket 60 of the fourth embodiment in that an inverted-E shaped metal gasket 40a is employed instead of the substantially-E shaped metal gasket 30a, the two valley portions 12b provided on the non-fluid side are formed to be smaller than the valley portion 11b provided on the fluid side to be sealed and a metallic rectangular section ring 30h is fitted to the valley portion 11b provided on the fluid side. In the ring-shaped metal gasket 80, it is permissible to omit the metallic rectangular section ring 30h which is fitted to the valley portion 11b provided on the fluid side and fit the metallic rectangular section rings 30i, 30j to the valley portions 12b, 12b located on the non-fluid side (FIG. 11).

In the ring-shaped metal gaskets 30A, 60, 70, 80, 90, preferably, at least one of the metallic rings is fitted to the valley portion on a lower pressure side of the fluid side X to be sealed and the non-fluid side Yon the opposite side. For example, in case of sealing the vacuum apparatus as shown in FIG. 6, if the pressure P_{X} on the fluid side X to be sealed and the pressure P_{Y} on the non-fluid side Y on the opposite side are in the relationship of P_{X}≦P_{Y}, metallic O-rings 30b, 30c are fitted to the valley portion 11b and the valley portion 31b located on the fluid side X to be sealed. Further, in case of sealing a high pressure fluid pipe as shown in FIG. 7, if the pressure P_{X} on the fluid side to be sealed and the pressure P_{Y} on the non-fluid side Y on the opposite side are in the relationship of P_{X}≦P_{Y}, a metallic O-ring 30d is fitted to the valley portion 12b on the non-fluid side. Consequently, in case of a gasket produced of thin plate, even if deformation due to a difference in pressure occurs in the direction of an arrow b (FIG. 6) or in the direction of an arrow c (FIG. 7), this does not lead to plastic deformation thereby possibly causing no damage because the reinforcement metallic O-rings 30b, 30c (FIG. 6) or 30d is fitted thereto. If a metallic O-ring is fitted not to the fluid side but to the valley portion 12b located on the non-fluid side although not shown, the gasket becomes likely to be deformed in a direction in which the shape C of the C-shaped section portion 11a, 31a is crushed, however because the metallic O-ring fitted to the valley portion 12b acts as a reinforcement member against a compressive load in the tightening direction (first direction), the plastic deformation of the gasket can be prevented thereby possibly causing no damage also. In the meantime, the same effect is exerted even if the metallic O-ring is a metallic rectangular section ring.

In the ring-shaped metal gaskets 30A, 60, 70, 80, 90, preferably, one of the metallic rings is fitted to the valley portion located on a lower temperature side of the fluid side X to be sealed and the non-fluid side on the opposite side. For example, if the temperature pressure T_{X} on the fluid side X to be sealed and the temperature T_{Y} on the non-fluid side Y located on the opposite side are in the relationship of T_{Y}≦T_{X}, the metallic ring is fitted to the valley portion 12b located on the non-fluid side Y. Consequently, heat received by the ring-like gasket is transmitted to a sealing object member so as to suppress heat influence upon the metallic ring, so that its heat resistance is improved.

The ring-shaped metal gaskets 30A, 60, 70, 80, 90 of the third to fifth embodiment can be used at the same use position as the ring-shaped metal gasket 10 of the first embodiment and the use condition and effect are the same also.

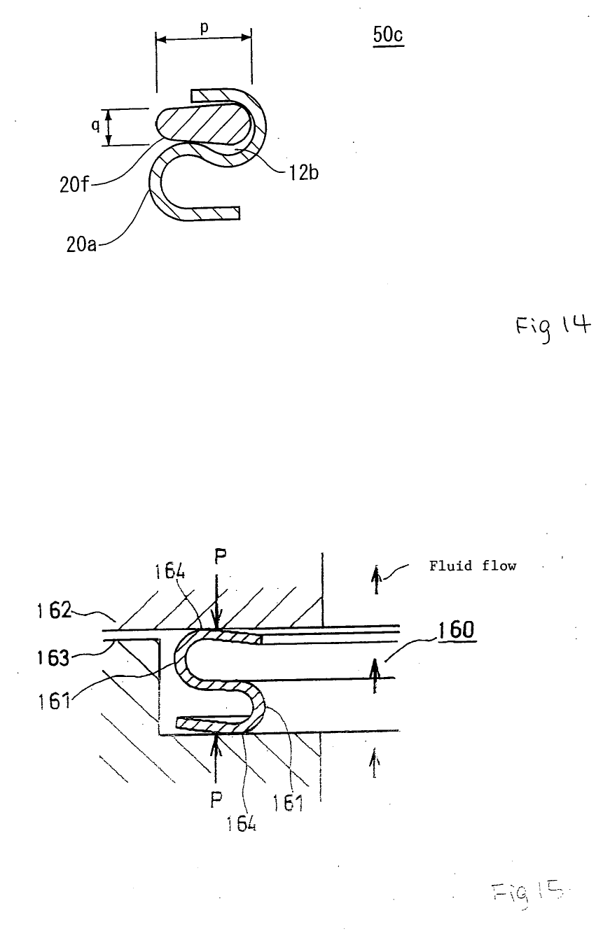

The ring-shaped metal gasket of the sixth embodiment of the present invention will be described with reference to FIGS. 12-14. In FIG. 12, like reference numerals are attached to the same components as FIG. 2 and description thereof is omitted while mainly different points will be described. That is, the ring-shaped metal gasket 50a of the sixth embodiment is different from the ring-shaped metal gasket 10 shown in FIG. 2 in that the inverted-S shaped metal gasket 20a is employed instead of the S-shaped metal gasket 10a and that a metallic irregular cross section ring 20d is fitted to the valley portion 12b located on the non-fluid side. The metallic irregular cross section ring 20d is not restricted to any particular one as long as the maximum dimension p in the diameter direction (n direction) in its longitudinal section is larger than the maximum dimension q in a direction (m direction) perpendicular to the diameter direction and for example, a metallic elliptic cross section ring 20e (FIG. 13), a metallic oval cross section ring 20f (FIG. 14), the metallic rectangular cross section ring 20b (FIG. 13(D))and the like can be mentioned. In case of the ring-shaped metal gasket 50a-50c of the sixth embodiment, the effect of suppressing plastic deformation in the vicinity of the junction point 11c between the C-shaped section portion and the inverted-C shaped section portion is considerably high.

Although two sealing object members on which the ring-shaped metal gasket of the present invention is mounted are sealing object members comprising one flange and a mating flange, the present invention is not restricted to this example, but this is applicable to sealing for, for example, sealing object members used in half cut condition, sealing object members formed of different materials and the like.

In the ring-shaped metal gasket of the present invention which is disposed between two sealing object members and in which at least two pieces of the valley portions dented in the second direction perpendicular to the first direction extending from the contact portion of one sealing object member to the contact portion of the other sealing object member are provided, because the metallic ring, for example, the metallic O-ring or the metallic rectangular cross section ring is fitted to at least one of the valley portions, even if an excessive compressive load is applied, the metallic ring fitted to the valley portion acts as a reinforcement member, suppressing the plastic deformation of the ring-shaped metal gasket and at the same time, preventing generation of metal fatigue in the ring-shaped metal gasket. Further, if the metallic rings are provided in the valley portions of both the fluid side and non-fluid side, an influence on the metal gasket by changes in pressure between the fluid side and non-fluid side can be suppressed.

Because according to the ring-shaped metal gasket of the present invention, at least one of the metallic rings is fitted to the valley portion on a lower pressure side of valleys on the fluid side to be sealed and the non-fluid side on the opposite side, even if a difference in pressure between the fluid side to be sealed and the non-fluid side on the opposite side increases, the thickness of the ring-shaped metal gasket can be reduced because a reinforcement metallic ring is fitted to the deformation side, so that a damage due to the reduced thickness can be prevented.

Further, because in the ring-shaped metal gasket of the present invention, at least one of the metallic rings is fitted to the valley portion on a lower temperature side of valleys on the fluid side to be sealed and the non-fluid side on the opposite side, heat received by the ring-shaped gasket is transmitted to a sealing object member, so that heat influence upon the metallic ring can be suppressed and at the same time, its heat resistance is improved.

Further, because in the ring-shaped metal gasket of the present invention, the metallic rings are fitted to all the valley portions of the ring-shaped metal gasket, it is not necessary to take care of a position (direction) in which the metallic ring is fitted when the ring-shaped metal gasket is installed and therefore, a mistake in installation can be prevented. Further, because this ring-shaped metal gasket can substitute a gasket in which a metallic ring is fitted to only one side of plural valley portions, it is not necessary to prepare a gasket in which the metallic ring is fitted to only this one side and therefore, the quantity of components can be reduced.

Further, the ring-shaped metal gasket of the present invention has a high effect of suppressing the plastic deformation in the vicinity of the junction point between the C-shaped section portion and the inverted-C shaped portion in the, for example, S-shaped or inverted-S shaped metal gasket even if an excessive compressive load is applied.

The ring-shaped metal gasket of the present invention increases a room for material selection when manufacturing the ring-shaped metal gasket.

### INDUSTRIAL APPLICABILITY

The present invention is applicable as seal for a vacuum apparatus, a sealing gasket of a pressure fluid pipe and the like.

1. A ring-shaped metal gasket which is disposed between two sealing object members and in which at least two pieces of valley portions dented in a second direction perpendicular to a first direction extending from a contact portion of one sealing object member to the other sealing object member are provided, wherein a metallic ring is fitted to at least one of said valley portions.

2. The ring-shaped metal gasket according to claim 1 wherein at least one of said metallic rings is fitted to the valley portion on a lower pressure side of a fluid side to be sealed and a non-fluid side on the opposite side.

3. The ring-shaped metal gasket according to claim 1 wherein at least one of said metallic rings is fitted to the valley portion on a lower temperature side of the fluid side to be sealed and the non-fluid side on the opposite side.

4. The ring-shaped metal gasket according to claim 1 wherein said metallic rings are fitted to all the valley portions of the ring-shaped metal gasket.

5. The ring-shaped metal gasket according to claim 1 wherein the maximum dimension in the diameter direction of a longitudinal section is larger than the maximum dimension in a direction perpendicular to the diameter direction.

6. The ring-shaped metal gasket according to claim 5 wherein said metallic ring is a metallic O-ring, metallic irregular cross section ring or metallic rectangular cross section ring.

7. The ring-shaped metal gasket according to claim 2 wherein the maximum dimension in the diameter direction of a longitudinal section is larger than the maximum dimension in a direction perpendicular to the diameter direction.

8. The ring-shaped metal gasket according to claim 3 wherein the maximum dimension in the diameter direction of a longitudinal section is larger than the maximum dimension in a direction perpendicular to the diameter direction.

9. The ring-shaped metal gasket according to claim 4 wherein the maximum dimension in the diameter direction of a longitudinal section is larger than the maximum dimension in a direction perpendicular to the diameter direction.

10. The ring-shaped metal gasket according to claim 7 wherein said metallic ring is a metallic O-ring, metallic irregular cross section ring or metallic rectangular cross section ring.

11. The ring-shaped metal gasket according to claim 8 wherein said metallic ring is a metallic O-ring, metallic irregular cross section ring or metallic rectangular cross section ring.

12. The ring-shaped metal gasket according to claim 9 wherein said metallic ring is a metallic O-ring, metallic irregular cross section ring or metallic rectangular cross section ring.
